(19) United States
(12) Patent Application Publication
(10) Pub. No.: US 2022/0212433 A1
(43) Pub. Date: Jul. 7, 2022

(54) INFLATION NOZZLES FOR CLOSED CHANNEL WEB MATERIALS

(71) Applicant: Sealed Air Corporation (US), Charlotte, NC (US)

(72) Inventor: Garrett P. Dyer, Charlotte, NC (US)

(21) Appl. No.: 17/609,863

(22) PCT Filed: May 8, 2020
(86) PCT No.: PCT/US2020/031983

§ 371 Date: Nov. 9, 2021

Related U.S. Application Data
(60) Provisional application No. 62/845,361, filed on May 9, 2019.

(51) Int. Cl. B31D 5/00; B65B 55/20

(52) U.S. Cl. CPC B31D 5/0073; B65D 81/052; B65B 55/20

(57) ABSTRACT

A system includes a manifold block, a nozzle, and a blade carrier. The manifold block includes a gas inlet and a gas outlet. The gas outlet is in fluid communication with the gas inlet. The nozzle is configured to be coupled to the gas outlet of the manifold block, the nozzle including a conduit and a slot in the conduit. The blade carrier includes a body, a guard coupled to the body, and a blade coupled to the guard. The blade carrier is couplable to the manifold block so that so that a gap exists between the conduit and the guard. The wherein the blade is coupled to the blade carrier such that, when the blade carrier is couple to the manifold block, the blade is located in the gap between the conduit and the guard and a portion of the blade is located in the slot.

### BACKGROUND

The present disclosure is in the technical field of inflation nozzles for closed channel web materials. More particularly, the present disclosure is directed to nozzle assemblies that includes blade carriers that can be coupled to and removed from manifold blocks in a toolless manner.

Consumers frequently purchase goods from mail-order or internet retailers, which package and ship the goods to the purchasing consumer via a postal service or other carrier. Millions of such packages are shipped each day. These items are normally packaged in small containers, such as boxes or envelopes. To protect the items during shipment, they are typically packaged with some form of protective dunnage that may be wrapped around the item or stuffed into the container to prevent movement of the item and to protect it from shock.

Common types of mailing envelope are sometimes referred to as “mailers.” In some cases, these mailers have cushioning to provide some level of protection for the objects transported therein. The outer walls of cushioned mailers are typically formed from protective materials, such as Kraft paper, cardstock, polyethylene-coated paper, other paper-based materials, polyethylene film, or other resilient materials. The inner walls of cushioned mailers are lined with cushioning materials, such as air cellular material (e.g., BUBBLE WRAP™ air cellular material sold by Sealed Air Corporation), foam sheets, or any other cushioning material. The outer walls are typically adhered (e.g., laminated) to the cushioning material when forming the mailers.

When goods are shipped in rigid containers, such as corrugated cardboard boxes, dunnage material is typically added to the containers to take up some of the void space within the containers. Inflated cushions, pillows, or other inflated containers are common void fill materials that are either placed loose in a container with an object or wrapped around an object that is then placed in a container. The cushions protect the packaged item by absorbing impacts that may otherwise be fully transmitted to the packaged item during transit, and also restrict movement of the packaged item within the carton to further reduce the likelihood of damage to the item. Another common form of void fill material is paper, such as Kraft paper, that has been folded or crumped into a low-density, three-dimensional pad or wad that is capable of filling void space without adding significant weight to the container.

It would be advantageous to automate the packaging process to minimize the amount of time required to package objects properly. However, given the wide variety of ways which objects can be packaged for shipping, automation of the packaging process can be challenging.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a system includes a manifold block, a nozzle, and a blade carrier. The manifold block includes a gas inlet and a gas outlet. The gas outlet is in fluid communication with the gas inlet. The nozzle is configured to be coupled to the gas outlet of the manifold block, the nozzle including a conduit and a slot in the conduit. The blade carrier includes a body, a guard coupled to the body, and a blade coupled to the guard. The blade carrier is couplable to the manifold block so that so that a gap exists between the conduit and the guard. The wherein the blade is coupled to the blade carrier such that, when the blade carrier is couple to the manifold block, the blade is located in the gap between the conduit and the guard and a portion of the blade is located in the slot.

In a second embodiment, the guard of the blade carrier of the first embodiment is configured to be aligned with the slot when the blade carrier is coupled to the manifold block.

In a third embodiment, the nozzle of any of the previous embodiments further includes a wear cap configured to close an end of the conduit.

In a fourth embodiment, the blade of the previous embodiments is arranged so that, when the blade carrier is coupled to the manifold block, the blade extends farther forward along the conduit than the blade extends forward along the guard.

In a fifth embodiment, the blade carrier of the previous embodiments is removably couplable to the manifold block.

In a sixth embodiment, the blade carrier of the previous embodiments is configured to be coupled to a nozzle portion of the manifold block.

In a seventh embodiment, a system includes a manifold block, a nozzle, and a blade carrier. The manifold block comprising a gas inlet and a gas outlet. The gas outlet is in fluid communication with the gas inlet. The nozzle configured to be coupled to the gas outlet of the manifold block. The blade carrier includes a body having a bore therein, a guard coupled to the body so that a gap exists between a portion of the body and a portion of the guard, and a blade located in the gap between the portion of the body and the portion of the guard. The blade carrier is configured to be coupled to the manifold block in a toolless manner by sliding a portion of the nozzle through at least a portion of the bore until the blade carrier is in contact with the manifold block.

In an eighth embodiment, the manifold block of the seventh embodiment includes a slot and wherein the guard of the blade carrier is configured to be aligned with the slot when the blade carrier is coupled to the manifold block.

In a ninth embodiment, the manifold block of the eighth embodiment further includes side walls on either side of the slot. The side walls are configured to deter rotation of the blade carrier.

In a tenth embodiment, the manifold block of any of the eight to ninth embodiments further includes a ball detent in the slot.

In an eleventh embodiment, the guard of the tenth embodiment includes a ball detent depression configured to engage the ball detent in the slot. When the ball detent is engaged with the ball detent depression, the ball detent depression deters the blade carrier from moving away from the manifold block.

In a twelfth embodiment, the nozzle of any of the seventh to eleventh embodiments includes a conduit configured to be coupled to the gas outlet of the manifold block.

In a thirteenth embodiment, the system of the twelfth embodiment is configured such that, when the blade carrier is coupled to the manifold block, an end of the conduit extends beyond an end of the body of the blade carrier. The end of the conduit that extends beyond the end of the body of the blade carrier includes a wear cap. The manifold block and the nozzle are configured such that gas can be inserted into the gas inlet of the manifold block, pass through the manifold block, pass out of the manifold block and into the conduit through the gas outlet, and then pass out of the conduit through the wear cap.

In a fourteenth embodiment, the system of any one of the twelfth to thirteenth embodiments is configured such that, when the blade carrier is coupled to the manifold block, the conduit remains inside of the bore. The body of the blade carrier includes an outlet. The manifold block, the nozzle, and the blade carrier are configured such that gas can be inserted into the gas inlet of the manifold block, pass through the manifold block, pass out of the manifold block and into the conduit through the gas outlet, pass out of the conduit into the bore, and then pass out of the body of the blade carrier through the outlet.

In a fifteenth embodiment, the body of the blade carrier of the fourteenth embodiment includes a wear cap. When the blade carrier is coupled to the manifold block, the wear cap is on an end of the body that is furthest from the manifold block.

In a sixteenth embodiment, the system of any of the seventh to fifteenth embodiments is configured such that the body includes a first slot, the guard includes a second slot, and a bottom of the blade is configured to slide in the first slot and a top of the blade is configured to slide in the second slot.

In a twentieth embodiment, the blade carrier of the sixteenth embodiment includes a set screw configured to hold the blade in place with respect to the body and the guard.

In an eighteenth embodiment, the blade of any of the sixteenth and seventeenth embodiments is arranged so that the blade extends farther forward along the body than the blade extends forward along the guard.

In a nineteenth embodiment, the gas inlet of any of the seventh to eighteenth embodiments is configured to be coupled to a connector and wherein the connector is configured to be coupled to a gas source.

In a twentieth embodiment, the manifold block of any of the seventh to nineteenth embodiments includes a mounting portion and a nozzle portion. The gas inlet is in the mounting portion. The gas outlet is in the nozzle portion.

In a twenty first embodiment, the nozzle portion of the twentieth embodiment is narrower than the mounting portion.

In a twenty second embodiment, a width of the nozzle portion of any of the twentieth to twenty first embodiments is similar to a width of the body.

In a twenty third embodiment, a method includes mounting a manifold block to a support structure, coupling a gas inlet of the manifold block to a gas source, and coupling a nozzle to a gas outlet of the manifold block. The gas inlet is in fluid communication with the gas outlet. The method further includes coupling, in a toolless manner, a blade carrier to the manifold block by sliding a portion of the nozzle through at least a portion of a bore of the blade carrier until the blade carrier is in contact with the manifold block. The bore of the blade carrier is in a body of the blade carrier. The blade carrier further includes a guard coupled to the body so that a gap exists between a portion of the body and a portion of the guard. The blade carrier further includes a blade located in the gap between the portion of the body and the portion of the guard.

In a twenty fourth embodiment, the manifold block of the twenty third embodiment includes a slot and the coupling of the blade carrier to the manifold block further includes aligning the guard with the slot.

In a twenty fifth embodiment, the blade carrier of any of the twenty third to twenty fourth embodiments is in contact with the manifold block when a ball detent of the manifold block is engaged with a ball detent depression in the blade carrier.

In a twenty sixth embodiment, a web material of any of the twenty third to twenty fifth embodiments includes a closed channel in fluid communication with a plurality of chambers. The method further includes feeding the web material past the manifold block so that the closed channel passes around the body of the blade carrier and the closed channel is cut by the blade.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIGS. 1A and 1B depict perspective and exploded perspective views, respectively, of an embodiment of a nozzle assembly for use with closed channel web materials, in accordance with the embodiments disclosed herein;

FIGS. 2A and 2B depict top and bottom perspective views, respectively, of a manifold block from the nozzle assembly shown in FIGS. 1A and 1B, in accordance with the embodiments disclosed herein;

FIG. 3 depicts a perspective view of a nozzle from the nozzle assembly shown in FIGS. 1A and 1B, in accordance with the embodiments disclosed herein;

FIG. 4 depicts a perspective view of a blade carrier from the nozzle assembly shown in FIGS. 1A and 1B, in accordance with the embodiments disclosed herein;

FIG. 5 depicts an example of the nozzle assembly shown in FIGS. 1A and 1B being used to inflate and cut an inflatable web material, in accordance with the embodiments disclosed herein;

FIGS. 6A and 6B depict perspective and exploded perspective views, respectively, of another embodiment of a nozzle assembly for use with closed channel web materials, in accordance with the embodiments disclosed herein;

FIGS. 7A and 7B depict top and bottom perspective views, respectively, of a manifold block from the nozzle assembly shown in FIGS. 6A and 6B, in accordance with the embodiments disclosed herein;

FIG. 8 depicts a perspective view of a nozzle from the nozzle assembly shown in FIGS. 6A and 6B, in accordance with the embodiments disclosed herein;

FIGS. 9A, 9B, and 9C depict various perspective views of a blade carrier from the nozzle assembly shown in FIGS. 6A and 6B, in accordance with the embodiments disclosed herein; and

FIG. 10 depicts an example of the nozzle assembly shown in FIGS. 6A and 6B being used to inflate and cut an inflatable web material, in accordance with the embodiments disclosed herein.

### DETAILED DESCRIPTION

The present disclosure describes embodiments of nozzle assemblies that can be used to inflate closed channel web materials. In some embodiments, the nozzle assembly includes a manifold block, a nozzle, and a blade carrier. The manifold block includes a gas inlet and a gas outlet. The gas outlet is in fluid communication with the gas inlet. The nozzle is configured to be coupled to the gas outlet of the manifold block. The blade carrier includes a body having a bore therein, a guard coupled to the body so that a gap exists between a portion of the body and a portion of the guard, and a blade located in the gap between the portion of the body and the portion of the guard. The blade carrier is configured to be coupled to the manifold block in a toolless manner by sliding a portion of the nozzle through at least a portion of the bore until the blade carrier is in contact with the manifold block. By being couplable and removable in a toolless manner, the blade carrier and the blade are easily replaceable when the blade and/or any other wearable part needs to be replaced.

Web materials can be formed into a pouch for packaging an object. In some embodiments, web materials are inflatable air cellular material. As used herein, the term “air cellular material” herein refers to bubble cushioning material, such as BUBBLE WRAP® air cushioning material sold by Sealed Air Corporation, where a first film or laminate is formed (e.g., thermoformed, embossed, calendared, or otherwise processed) to define a plurality of cavities and a second film or laminate is adhered to the first film or laminate in order to close the cavities. Examples of air cellular materials are shown in U.S. Pat. Nos. 3,142,599, 3,208,898, 3,285,793, 3,508,992, 3,586,565, 3,616,155, 3,660,189, 4,181,548, 4,184,904, 4,415,398, 4,576,669, 4,579,516, 6,800,162, 6,982,113, 7,018,495, 7,165,375, 7,220,476, 7,223,461, 7,429,304, 7,721,781, and 7,950,433, and U.S. Published Patent Application Nos. 2014/0314978 and 2015/0075114, the disclosures of which are hereby incorporated by reference in their entirety.

As used herein, an “object” may comprise a single item for packaging or grouping of several distinct items where the grouping is to be in a single package. Further, an object may include an accompanying informational item, such as a packing slip, tracking code, a manifest, an invoice, or printed sheet comprising machine-readable information (e.g., a bar code) for sensing by an object reader (e.g., a bar code scanner). In some embodiments, each of the objects includes an object identifier. In some examples, the object identifier includes one or more of a barcode, a quick response (QR) code, a radio frequency identification (RFID) tag, any other form a machine-readable information, human-readable information, or any combination thereof.

In some embodiments, a web material includes two longitudinal edges. Between the longitudinal edges are two juxtaposed sheets (e.g., sheets of film) that are sealed together to form chambers. When initially formed, the chambers are in an uninflated state and the chambers are capable of being inflated. In some embodiments, each of the chambers extends substantially transversely across the web material and the pattern of the chambers generally repeats in the longitudinal direction.

In some embodiment, each of the chambers includes a port that is open and a distal end that is closed. The ports can be located proximate one of the two longitudinal edges and the distal ends located proximate the other of the two longitudinal edges so that the ports extend substantially transversely across the web material. The juxtaposed sheets are sealed between the ports and the distal ends such that each of the chambers has substantially circular cells that are interconnected by channels that are narrower than the widest point of the cells. The chambers are capable of being inflated by inserting a gas (e.g., air) through the ports. Once the chambers are inflated, the cells form three-dimensional shapes (sometimes referred to as “bubbles”) along the inflated chambers. In some embodiments, a pair of adjacent chambers are offset so that the cells of one of the chambers are aligned with the interconnecting channels of a subsequent one of the chambers.

To aid in inflation of the chambers, the web material can include a common channel that is in fluid communication with each of the chambers. In some embodiments, a nozzle can be inserted in the common channel and direct a gas into the common channel. The gas inserted into the common channel can pass through the ports to inflate the chambers. Coupled to the nozzle may be a sealing device configured to close the ports after inflation of the chambers. Examples of web materials with common channels are described in U.S. Patent Application No. 62/783,250, and in U.S. Patent Application No. 62/845,354, the contents of each of which are hereby incorporated by reference in their entirety.

In some embodiments, the common channel of an inflatable web material can be an “open” channel where the two sheets are not connected to each other. An open channel allows a nozzle to be located in the common channel while the two sheets of the channel are able to pass on either side of the nozzle without cutting the channel. In other embodiments, the common channel of an inflatable web material can be a “closed” channel where the two sheets are connected to each other. A nozzle can be inserted into the closed channel. The closed channel may improve inflatability of the chambers because the possibility of the gas to exit a closed channel is significantly lower than with an open channel. However, a closed channel requires the two sheets to be cut before the sheets can pass on either side of the nozzle.

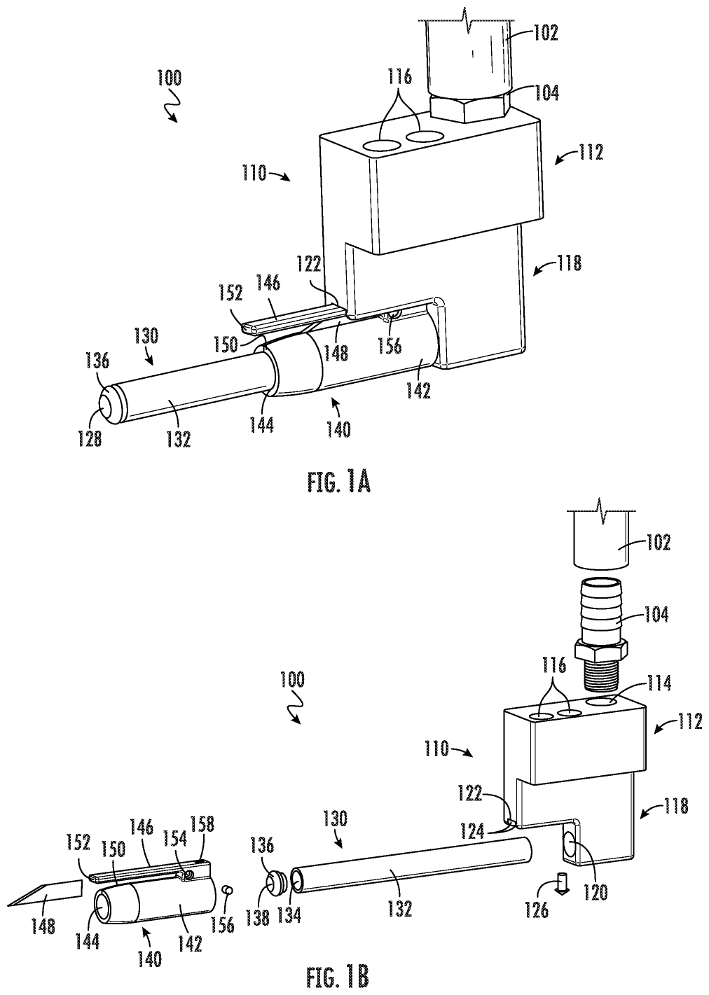

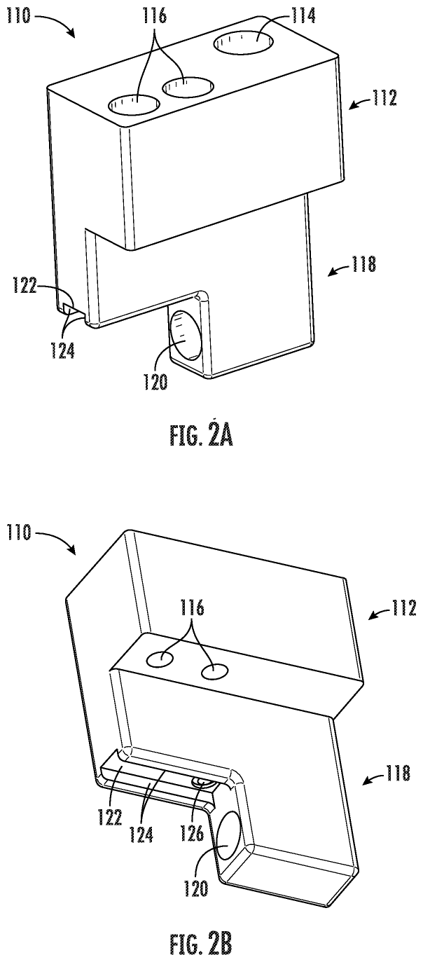

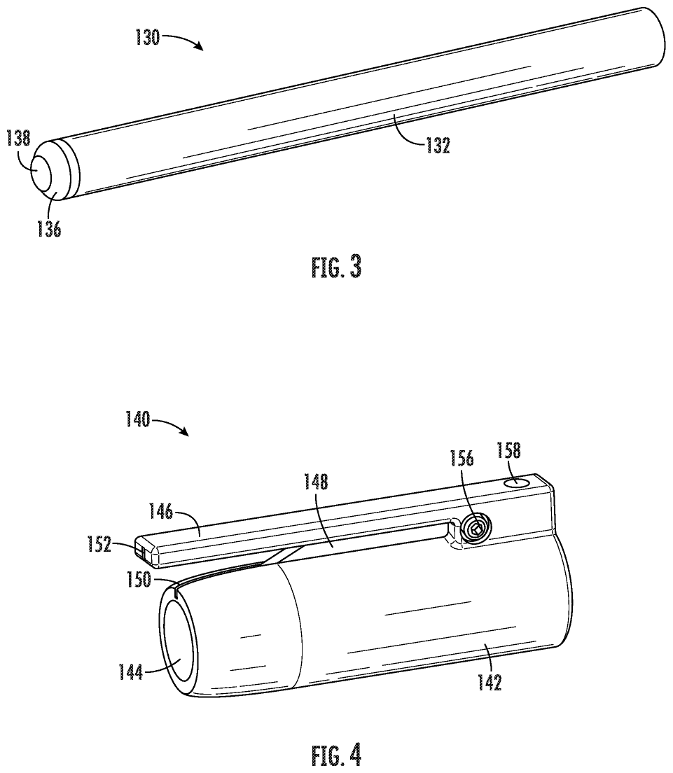

Depicted in FIGS. 1A and 1B are perspective and exploded perspective views, respectively, of an embodiment of a nozzle assembly 100 for use with closed channel web materials. The nozzle assembly 100 includes a manifold block 110, a nozzle 130, and a blade carrier 140. FIGS. 2A and 2B depict more detailed top and bottom perspective views, respectively, of the manifold block 110. FIG. 3 depicts a more detailed perspective view of the nozzle 130. FIG. 4 depicts a more detailed perspective view of the blade carrier 140.

The nozzle assembly 100 is configured to convey gas from a gas source 102 into a closed channel of an inflatable web material and to cut open the closed channel of the inflatable web material. In the depicted embodiment, the gas source 102 is a gas line that can be coupled to a compressor, a pressure gas container (e.g., a cylinder), and the like. Also depicted in FIGS. 1A and 1B is a connector 104 configured to couple the gas source 102 to the manifold block 110. In other embodiments, the gas source 102 may be connected directly to the manifold block 110 and/or coupled to the manifold block 110 via a different type of connector.

The manifold block 110 includes a mounting portion 112. The mounting portion 112 of the manifold block 110 includes a gas inlet 114. In some embodiments, the gas inlet 114 is a threaded bore into which a threaded end of the connector 104 can be coupled. In the depicted embodiment, the mounting portion 112 of the manifold block 110 includes mounting holes 116. In some embodiments, a fastener (e.g., a bolt, a machine screw, etc.) can be inserted through each of the mounting holes 116 to mount the manifold block 110 to a structure, such as a support structure of an automated packaging station.

The manifold block 110 also includes a nozzle portion 118. The nozzle portion 118 of the manifold block 110 includes a gas outlet 120. The gas outlet 120 is in fluid communication with the gas inlet 114 so that gas that passes into the gas inlet 114 passes to the gas outlet 120. In the depicted embodiment, the nozzle portion 118 includes a slot 122. The slot 122 is positioned on a down-ward facing surface of the manifold block 110. The slot 122 has side walls 124. In some embodiments, the slot 122 is linear and extends substantially parallel to and aligned with an axis of the gas outlet 120. The manifold block 110 also includes a ball detent 126. In the depicted embodiment, the ball detent 126 is positioned in the slot 122.

The nozzle assembly 100 includes a nozzle 130. The nozzle 130 includes a conduit 132 that has a passageway 134 for passage of gas. The conduit 132 is configured to be coupled to the gas outlet 120 of the manifold block 110. In some embodiments, the conduit 132 is an aluminum tube that can be pressed into the gas outlet 120 to couple the nozzle 130 to the manifold block 110. In some embodiment, an end of the conduit 132 includes external threads that can be threaded into internal threads of the gas outlet 120 to couple the nozzle 130 to the manifold block 110.

In the depicted embodiment, the nozzle 130 includes a wear cap 136 that forms an outlet 138. In the depicted embodiment, the wear cap 136 is couplable to an end of the conduit 132 that is opposite of the end of the conduit 132 that is coupled to the gas outlet 120. The wear cap 136 may contact a web material that is fed past the nozzle assembly 100, resulting in greater wear on the wear cap 136 than on other parts of the nozzle 130, such as the conduit 132. In some embodiments, the conduit 132 is made from a material (e.g., a metal, such as aluminum) that is more durable than a material (e.g., plastic) of the wear cap 136. In this way, the wear cap 136 may be a “wear part” that is intended to be replaced periodically but has a relatively low cost compared to the conduit 132.

The blade carrier 140 includes a body 142 that has a bore 144. In the depicted embodiment, the body 142 and the bore 144 are dimensioned so that the blade carrier 140 can slide over the conduit 132 with the conduit 132 passing through the bore 144. In some embodiments, the body 142 of the blade carrier 140 is made from a material that is the same or similar to the material of the conduit 132. In some embodiments, the body 142 of the blade carrier 140 is made from a material that is the different from the material of the conduit 132. For example, the body 142 of the blade carrier 140 can be made from a material (e.g., plastic) that wears more readily than the material (e.g., metal) of the conduit 132. In the depicted embodiment, the bore 144 of the blade carrier 140 is axially aligned with the conduit 132 of the nozzle 130.

The blade carrier 140 also includes a guard 146. In the depicted embodiment, the guard 146 is coupled to one end of the body 142. The guard 146 extends forward so that a gap exists between a portion of the body 142 and a portion of the guard 146. In the depicted embodiment, the guard 146 extends forward beyond the front of the body 142. In some embodiments, the gap between the portions of the body 142 and the guard 146 is sufficiently small to prevent or deter a user from inserting a finger or other body part into the gap between the portions of the body 142 and the guard 146.

The blade carrier 140 is configured to hold a blade 148 in the gap between the portions of the body 142 and the guard 146. In the depicted embodiment, the body 146 includes a slot 150 and the guard 146 includes a slot 152. The slots 150 and 152 are arranged so that a bottom of the blade 148 can be slid into the slot 150 and a top of the blade 148 can be slide into the slot 152. In the depicted embodiment, the blade 148 is arranged so that the blade 148 extends farther forward along the body 142 than the blade extends forward along the guard 146. In the depicted embodiment, the blade carrier 140 includes a set screw hole 154 and a set screw 156 configured to hold the blade 148 in place with respect to the body 142 and the guard 148. The guard 146 also includes a ball detent depression 158.

To assemble the nozzle assembly 100, the manifold block 110, the nozzle 130, and the blade carrier 140 can be assembled into the states shown in FIGS. 2A and 3B, FIG. 3, and FIG. 4, respectively. The nozzle 130 can then be coupled to the manifold block 110 by coupling an end of the conduit 132 (e.g., the end opposite from the wear cap 136) to the gas outlet 120 of the manifold block 110. The blade carrier 140 can be slid over the nozzle 130 so that the bore 144 passes over portions of the conduit 132 until the blade carrier 140 comes into contact with the manifold block 110. As the blade carrier 140 is slid along the nozzle 130, the guard 146 can be aligned with the slot 122 on the manifold block 110 so that the guard 146 passes between the side walls 124. The blade carrier 140 can continue sliding back along the nozzle 130 until the ball detent depression 158 is engaged with the ball detent 126. At that point, the ball detent 126 in the ball detent depression 158 deters the blade carrier 140 from unintentionally being slid away from the manifold block 110. The side walls 124 also deter the blade carrier 140 from rotating about the nozzle 130. In this way, the blade carrier 140 can be added to manifold block 110 and also removed from the manifold block 110 manually in a toolless manner (i.e., without the assistance of tools). This ability to add and remove the blade carrier 140 in a toolless manner can decrease the amount of time for a user to replace the blade carrier 140 when the blade 148 needs to be replaced.

In some embodiments, the body 142 of the blade carrier 140 can be made from a material (e.g., plastic) that wears more readily than the material (e.g., metal) of the conduit 132. In addition, in some embodiments, a majority of the surfaces of the nozzle assembly 100 that contact the film are on the body 142 of the blade carrier 140. In this way, a majority of the wear of the nozzle assembly 100 due to contact from the film during normal operation will be concentrated on the body 142 of the blade carrier 140. In other words, a majority of the wear of the nozzle assembly 100 due to contact from the film during normal operation will be on a “wear part” that is removable and replaceable in a toolless manner.

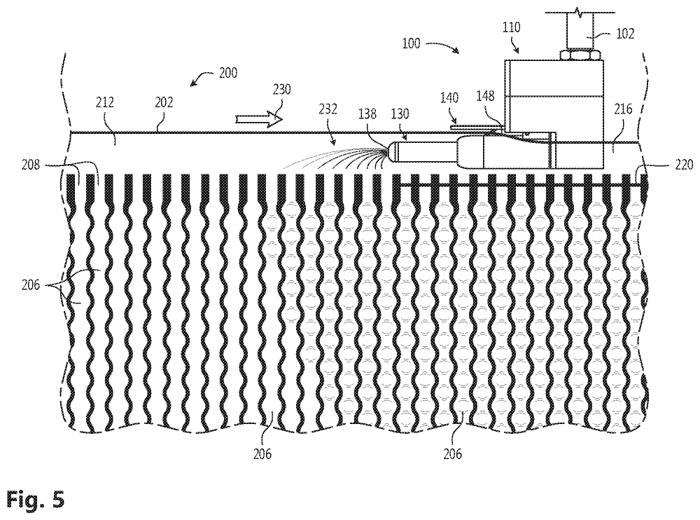

The nozzle assembly 100 is configured to inflate inflatable channels in an inflatable web with a closed channel and to cut open the closed channel in the inflatable web. Depicted in FIG. 5 is an example of the nozzle assembly 100 being used to inflate and cut an inflatable web material 200. The web material 200 includes a longitudinal edge 202. The web material 200 is formed from two juxtaposed sheets (e.g., sheets of film) that are sealed together to form chambers 206. In some embodiments, the chambers 206 are formed in an uninflated state and the chambers 206 are capable of being inflated. In the depicted embodiment, each of the chambers 206 extends substantially transversely across the web material 200 and the pattern of the chambers 206 generally repeats in the longitudinal direction.

In the depicted embodiment, each of the chambers 206 includes a port 208 that is open and a distal end (not shown) that is closed. The ports 208 are located proximate the longitudinal edge so that the ports 208 repeat longitudinally along the web material 200. The juxtaposed sheets are sealed between the ports 208 and the distal ends such that each of the chambers 206 has substantially circular cells that are interconnected by channels that are narrower than the widest point of the cells. The chambers 206 are capable of being inflated by inserting a gas (e.g., air) through the ports 208. Once the chambers 206 are inflated, the cells form three-dimensional shapes (sometimes referred to as “bubbles”) along the inflated chambers 206. In the depicted embodiment, a pair of adjacent chambers 206 are offset so that the cells of one of the chambers 206 are aligned with the interconnecting channels of a subsequent one of the chambers 206.

The web material includes a closed channel 212. In the depicted embodiment, the closed channel 212 is located proximate the longitudinal edge 202. In the depicted embodiment, the closed channel 212 is a “closed” channel because the two sides of the closed channel 212 are connected at the longitudinal edge 202. In this way, the closed channel 212 forms a loop above the ports 208. In the depicted embodiment, the closed channel 212 is in fluid communication with the chambers 206 via the ports 208.

To inflate the chambers 206, the web material 200 can be fed in a direction 230. In the depicted embodiment, the nozzle assembly 100 is positioned so that the direction 230 of the movement of the web material 200 is substantially parallel to the axis of the body 142 of the blade carrier 140. The web material 200 is fed so that the closed channel 212 passes over the nozzle 130 and the body 142 of the blade carrier 140. Gas 232 is inserted into the closed channel 212 from the outlet 138 of the nozzle 130. The gas 232 is fed from the gas source 102, through the manifold block 110, and through the conduit 132 before the gas 232 is inserted into the closed channel 212. The gas 232 inserted into the closed channel 212 then passes through the ports 208 to inflate the chambers 206.

In some embodiments, the nozzle assembly 100 may remain fixed and the web material 200 may be moved longitudinally in the direction 230. In this way, the nozzle assembly 100 can sequentially inflate the chambers 206. Coupled to the nozzle assembly 100 may be a sealing device (not shown) configured to close (e.g., seal closed) the ports 208 after inflation of the chambers 206. In the depicted embodiment, a longitudinal seal 220 that closes the ports 208 is shown. In the depicted embodiment, the longitudinal seal 220 is created starting from a point downstream of outlet 138 of the nozzle 130.

The web material 200 is fed past the nozzle assembly 100 so that a portion of the closed channel 212 passes between the body 142 and the guard 146 of the blade carrier 140. In the depicted embodiment, the longitudinal edge 202 passes between the body 142 and the guard 146 of the blade carrier 140. As the web material 200 moves longitudinally in the direction 230, the portion of the closed channel 212 that passes between the body 142 and the guard 146 of the blade carrier 140 comes into contact with the blade 148 and is cut by the blade. In the depicted embodiment, the closed channel 212 is cut by the blade 148 at or near the longitudinal edge 202 to form an open channel 216.

The open channel 216 is able to pass by the nozzle portion 118 of the manifold block 110, with the two sides of the open channel 216 passing on either side of the nozzle portion 118. In some embodiments, the nozzle portion 118 of the manifold block 110 is narrower than the mounting portion 112 of the manifold block 110. In the depicted embodiment, the width of the nozzle portion 118 is similar to the width of the body 142. The narrower nozzle portion 118 permits the two sides of the open channel 216 to pass on either side of the nozzle portion 118 relatively easily, while the wider mounting portion 110 has sufficient space for the gas inlet 114 to be coupled to the connector 104 and for the mounting holes 116 to be coupled to a fastener.

The inflation and cutting of closed-channel web materials causes the blade that cuts the closed channel to dull over time. After cutting some amount of web material, the blade is typically replaced. In some examples, the blade 148 is changed after using the blade 148 to cut through a specific number of supply rolls of the web material 200. One benefit to the nozzle assembly 100 is that the blade 148 is easily replaceable. In some embodiments, the blade carrier 140 can be removed and replaced by an entirely new blade carrier that has a fresh blade. Because the blade carrier 140 can be removed in a toolless manner and the replacement blade carrier can be replaced in a toolless manner, the changing of the blade 148 can be done quickly and efficiently, such as when a new supply roll of the web material 200 is loaded. In other embodiments, the blade carrier 140 is removed from the manifold block 110, the blade 148 is removed from the body 142, and new blade is installed in place of the blade 148, and the blade carrier 140 with the new blade is replaced back onto the manifold block 110. In any of these examples where the blade carrier 140 is removed from the manifold block 110, the manifold block 110 can remain mounted in place (e.g., mounted into an automated packaging station) while the blade carrier 140 is removed and replaced. This greatly reduces the amount of labor required and downtime of the machine to replace the blade 148 and/or the blade carrier 140.

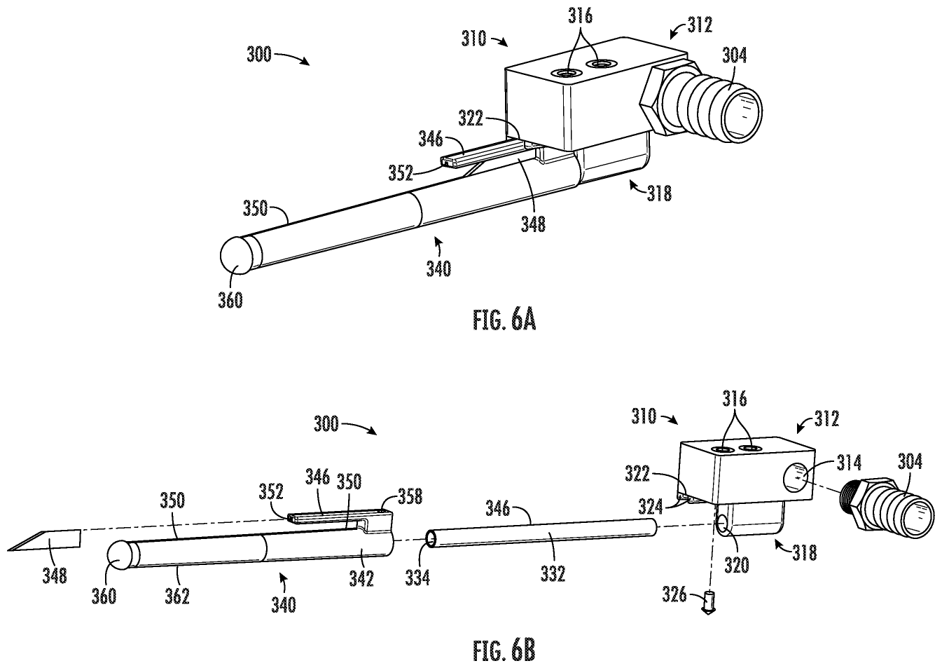

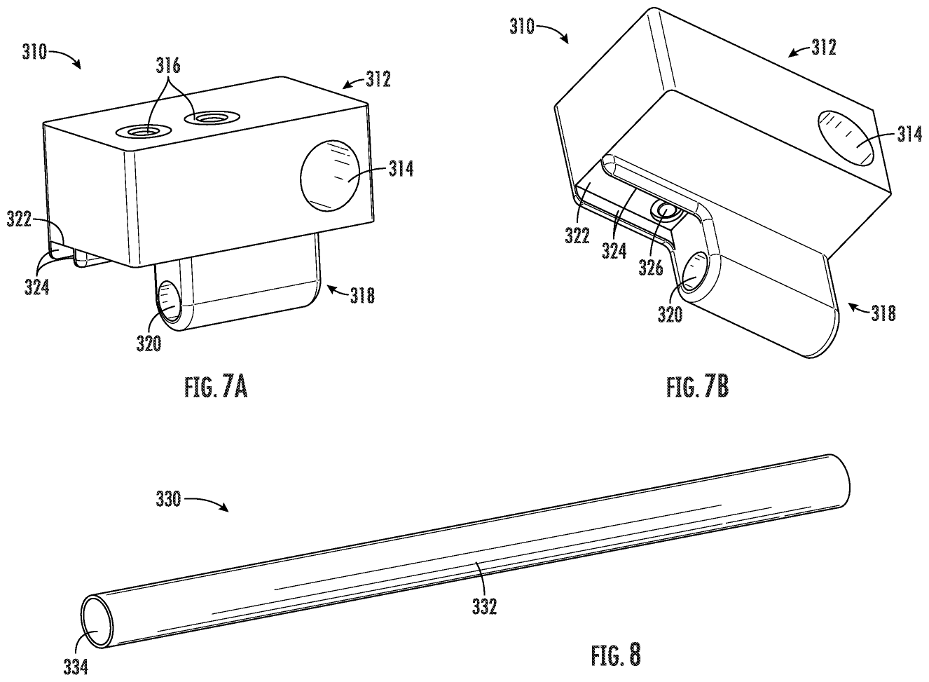

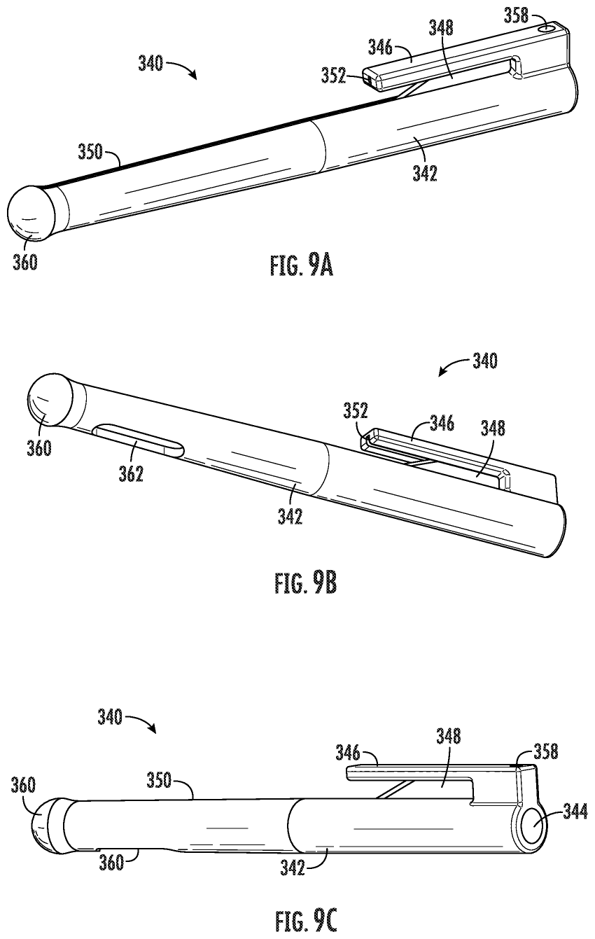

Depicted in FIGS. 6A and 6B are perspective and exploded perspective views, respectively, of another embodiment of a nozzle assembly 300 for use with closed channel web materials. The nozzle assembly 300 includes a manifold block 310, a nozzle 330, and a blade carrier 340. FIGS. 7A and 7B depict more detailed top and bottom perspective views, respectively, of the manifold block 310. FIG. 8 depicts a more detailed perspective view of the nozzle 330. FIGS. 9A to 9C depict more detailed perspective views of the blade carrier 340.

The nozzle assembly 300 is configured to convey gas from a source of gas into a closed channel of an inflatable web material and to cut open the closed channel of the inflatable web material. In some embodiments, the source of gas is a gas line that can be coupled to a compressor, a pressure gas container (e.g., a cylinder), and the like. Also depicted in FIGS. 6A and 6B is a connector 304 configured to couple the source of gas to the manifold block 310. In other embodiments, the source of gas may be connected directly to the manifold block 310 and/or coupled to the manifold block 310 via a different type of connector.

The manifold block 310 includes a mounting portion 312. The mounting portion 312 of the manifold block 310 includes a gas inlet 314. In some embodiments, the gas inlet 314 is a threaded bore into which a threaded end of the connector 304 can be coupled. In the depicted embodiment, the mounting portion 312 of the manifold block 310 includes mounting holes 316. In some embodiments, a fastener (e.g., a bolt, a machine screw, etc.) can be inserted through each of the mounting holes 316 to mount the manifold block 310 to a structure, such as a support structure of an automated packaging station.

The manifold block 310 also includes a nozzle portion 318. The nozzle portion 318 of the manifold block 310 includes a gas outlet 320. The gas outlet 320 is in fluid communication with the gas inlet 314 so that gas that passes into the gas inlet 314 passes to the gas outlet 320. In the depicted embodiment, the nozzle portion 318 includes a slot 322. The slot 322 is positioned on a down-ward facing surface of the manifold block 310. The slot 322 has side walls 324. In some embodiments, the slot 322 is linear and extends substantially parallel to and aligned with an axis of the gas outlet 320. The manifold block 310 also includes a ball detent 326. In the depicted embodiment, the ball detent 326 is positioned in the slot 322.

The nozzle assembly 300 includes a nozzle 330. The nozzle 330 includes a conduit 332 that has a passageway 334 for passage of gas. The conduit 332 is configured to be coupled to the gas outlet 320 of the manifold block 310. In some embodiments, the conduit 332 is an aluminum tube that can be pressed into the gas outlet 320 to couple the nozzle 330 to the manifold block 310.

The blade carrier 340 includes a body 342 that has a bore 344. In the depicted embodiment, the body 342 and the bore 344 are dimensioned so that the blade carrier 340 can be slid over the conduit 332 with the conduit 332 passing through the bore 344. In some embodiments, the body 342 of the blade carrier 340 is made from a material that is the same or similar to the material of the conduit 332. In some embodiments, the body 342 of the blade carrier 340 is made from a material that is the different from the material of the conduit 332. For example, the body 342 of the blade carrier 340 can be made from a material (e.g., plastic) that wears more readily than the material (e.g., metal) of the conduit 332. In the depicted embodiment, the bore 344 of the blade carrier 340 is axially aligned with the conduit 332 of the nozzle 330.

The blade carrier 340 also includes a guard 346. In the depicted embodiment, the guard 346 is coupled to one end of the body 342. The guard 346 extends forward so that a gap exists between a portion of the body 342 and a portion of the guard 346. In some embodiments, the gap between the portions of the body 342 and the guard 346 is sufficiently small to prevent or deter a user from inserting a finger or other body part into the gap between the portions of the body 342 and the guard 346.

The blade carrier 340 is configured to hold a blade 348 in the gap between the portions of the body 342 and the guard 346. In the depicted embodiment, the body 342 includes a slot 350 and the guard 346 includes a slot 352. The slots 350 and 352 are arranged so that a bottom of the blade 348 can be slid into the slot 350 and a top of the blade 348 can be slide into the slot 352. In the depicted embodiment, the blade 348 is arranged so that the blade 348 extends farther forward along the body 342 than the blade extends forward along the guard 346. The guard 346 also includes a ball detent depression 358.

The blade carrier 340 further has a wear cap 360. In the depicted embodiment, the wear cap 360 is a portion of the body 342 that is located at a leading end of the body 342. In this location, the wear cap 360 will be the point at which a web material will initially contact the blade carrier 340. The wear cap 360 can have any shape. In the depicted embodiment, the wear cap 360 has a substantially spherical shape that has a diameter that is larger than the diameter of the body 342 immediately adjacent to the wear cap 360. In some embodiments, the size and/or shape of the wear cap 360 is based on a size and/or shape of a closed channel of a web material that will be inflated by the nozzle assembly 300. The blade carrier 340 further includes an outlet 362 through which gas can pass out of the body 342. In the depicted embodiment, the outlet 362 is located on an opposite side of the body from the slot 350.

To assemble the nozzle assembly 300, the manifold block 310 and the blade carrier 340 can be assembled into the state shown in FIGS. 7A and 7B and in FIGS. 9A to 9C, respectively. The nozzle 330 can then be coupled to the manifold block 310 by coupling an end of the conduit 332 to the gas outlet 320 of the manifold block 310. The blade carrier 340 can be slid over the nozzle 330 so that the bore 344 passes over portions of the conduit 332 until the blade carrier 340 comes into contact with the manifold block 310. As the blade carrier 340 is slid along the nozzle 330, the guard 346 can be aligned with the slot 322 on the manifold block 310 so that the guard 346 passes between the side walls 324. The blade carrier 340 can continue sliding back along the nozzle 330 until the ball detent depression 358 is engaged with the ball detent 326. At that point, the ball detent 326 in the ball detent depression 358 deters the blade carrier 340 from unintentionally being slid away from the manifold block 310. The side walls 324 also deter the blade carrier 340 from rotating about the nozzle 330. In this way, the blade carrier 340 can be added to manifold block 310 and also removed from the manifold block 310 manually in a toolless manner. This ability to add and remove the blade carrier 340 in a toolless manner can decrease the amount of time for a user to replace the blade carrier 340 when the blade 348 needs to be replaced.

In contrast to the nozzle assembly 100, the nozzle 330 does not extend out beyond the end of the body 342 when the nozzle assembly 300 is assembled. The conduit 332 remains inside of the bore 344 in the body 342 of the blade carrier 340. As gas passes through the passageway 334 of the conduit 332, the gas passes out of the passageway 334, into the bore 344, and then out of the outlet 362. In this configuration, the blade carrier 340 covers the nozzle 330 prevents or deters web material from contacting the nozzle assembly. While the blade carrier 340 may be affected by wear due to the movements of web materials, the nozzle 330 would either have no wear or no significant effect from wear due to the movements of web materials.

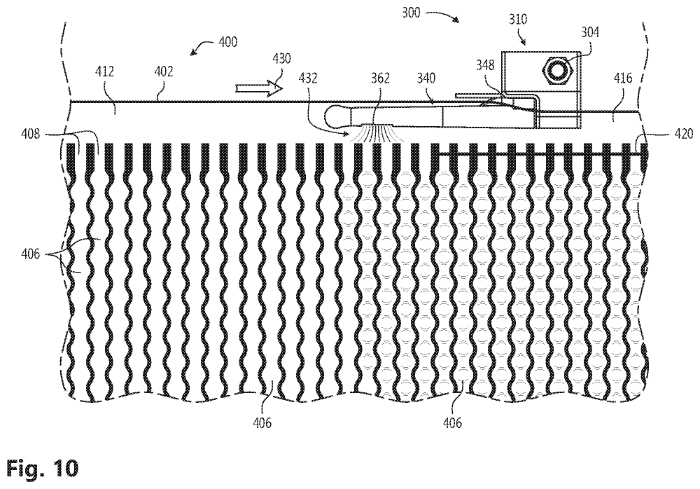

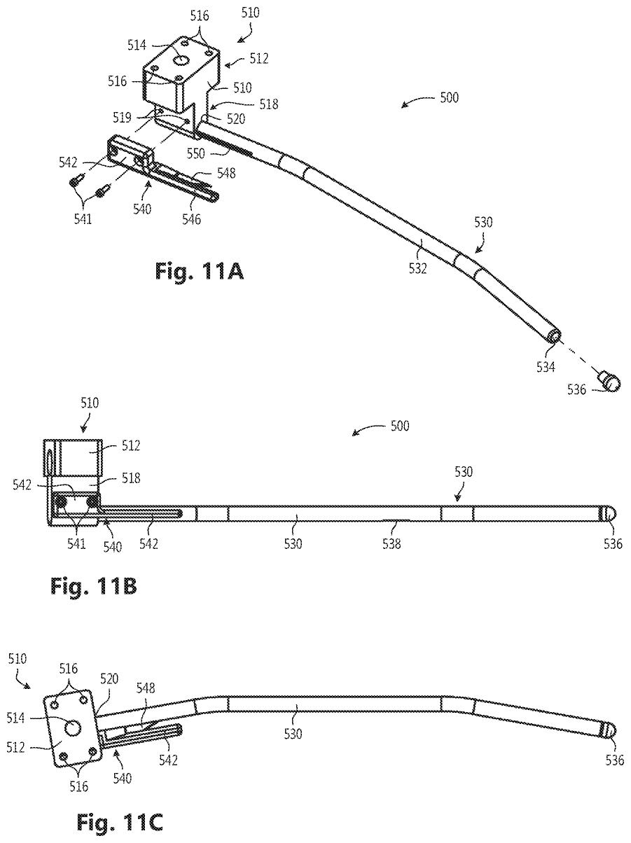

The nozzle assembly 300 is configured to inflate inflatable channels in an inflatable web with a closed channel and to cut open the closed channel in the inflatable web. Depicted in FIG. 10 is an example of the nozzle assembly 300 being used to inflate and cut an inflatable web material 400. The web material 400 includes a longitudinal edge 402. The web material 400 is formed from two juxtaposed sheets (e.g., sheets of film) that are sealed together to form chambers 406. In some embodiments, the chambers 406 are formed in an uninflated state and the chambers 406 are capable of being inflated. In the depicted embodiment, each of the chambers 406 extends substantially transversely across the web material 400 and the pattern of the chambers 406 generally repeats in the longitudinal direction.

In the depicted embodiment, each of the chambers 406 includes a port 408 that is open and a distal end (not shown) that is closed. The ports 408 are located proximate the longitudinal edge so that the ports 408 repeat longitudinally along the web material 400. The juxtaposed sheets are sealed between the ports 408 and the distal ends such that each of the chambers 406 has substantially circular cells that are interconnected by channels that are narrower than the widest point of the cells. The chambers 406 are capable of being inflated by inserting a gas (e.g., air) through the ports 408. Once the chambers 406 are inflated, the cells form three-dimensional shapes (sometimes referred to as “bubbles”) along the inflated chambers 406. In the depicted embodiment, a pair of adjacent chambers 406 are offset so that the cells of one of the chambers 406 are aligned with the interconnecting channels of a subsequent one of the chambers 406.

The web material includes a closed channel 412. In the depicted embodiment, the closed channel 412 is located proximate the longitudinal edge 402. In the depicted embodiment, the closed channel 412 is a “closed” channel because the two sides of the closed channel 412 are connected at the longitudinal edge 402. In this way, the closed channel 412 forms a loop above the ports 408. In the depicted embodiment, the closed channel 412 is in fluid communication with the chambers 406 via the ports 408.

To inflate the chambers 406, the web material 400 can be fed in a direction 430. In the depicted embodiment, the nozzle assembly 300 is positioned so that the direction 430 of the movement of the web material 400 is substantially parallel to the axis of the body 342 of the blade carrier 340. The web material 400 is fed so that the closed channel 412 passes over the blade carrier 340. Gas 432 is inserted into the closed channel 412 from the outlet 362 of the body 342. The gas 432 is fed from the gas source, through the manifold block 310, through the conduit 332, and out of the outlet 362 before the gas 432 is inserted into the closed channel 412. The gas 432 inserted into the closed channel 412 then passes through the ports 408 to inflate the chambers 406.

In some embodiments, the nozzle assembly 300 may remain fixed and the web material 400 may be moved longitudinally in the direction 430. In this way, the nozzle assembly 300 can sequentially inflate the chambers 406. Coupled to the nozzle assembly 300 may be a sealing device (not shown) configured to close (e.g., seal closed) the ports 408 after inflation of the chambers 406. In the depicted embodiment, a longitudinal seal 420 that closes the ports 408 is shown. In the depicted embodiment, the longitudinal seal 420 is created starting from a point downstream of the outlet 362 of the blade carrier 340.

The web material 400 is fed past the nozzle assembly 300 so that a portion of the closed channel 412 passes between the body 342 and the guard 346 of the blade carrier 340. In the depicted embodiment, the longitudinal edge 402 passes between the body 342 and the guard 346 of the blade carrier 340. As the web material 400 moves longitudinally in the direction 430, the portion of the closed channel 412 that passes between the body 342 and the guard 346 of the blade carrier 340 comes into contact with the blade 348 and is cut by the blade. In the depicted embodiment, the closed channel 412 is cut by the blade 348 at or near the longitudinal edge 402 to form an open channel 416.

The open channel 416 is able to pass by the nozzle portion 318 of the manifold block 310, with the two sides of the open channel 416 passing on either side of the nozzle portion 318. In some embodiments, the nozzle portion 318 of the manifold block 310 is narrower than the mounting portion 312 of the manifold block 310. In the depicted embodiment, the width of the nozzle portion 318 is similar to the width of the body 342. The narrower nozzle portion 318 permits the two sides of the open channel 416 to pass on either side of the nozzle portion 318 relatively easily, while the wider mounting portion 310 has sufficient space for the gas inlet 314 to be coupled to the connector 304 and for the mounting holes 316 to be coupled to a fastener.

The inflation and cutting of closed-channel web materials causes the blade that cuts the closed channel to dull over time. After cutting some amount of web material, the blade is typically replaced. In some examples, the blade 348 is changed after using the blade 348 to cut through a specific number of supply rolls of the web material 400. One benefit to the nozzle assembly 300 is that the blade 348 is easily replaceable. In some embodiments, the blade carrier 340 can be removed and replaced by an entirely new blade carrier that has a fresh blade. Because the blade carrier 340 can be removed in a toolless manner (i.e., without the assistance of tools) and the replacement blade carrier can be replaced in a toolless manner, the changing of the blade 348 can be done quickly and efficiently, such as when a new supply roll of the web material 400 is loaded. In other embodiments, the blade carrier 340 is removed from the manifold block 310, the blade 348 is removed from the body 342, and new blade is installed in place of the blade 348, and the blade carrier 340 with the new blade is replaced back onto the manifold block 310. In any of these examples where the blade carrier 340 is removed from the manifold block 310, the manifold block 310 can remain mounted in place (e.g., mounted into an automated packaging station) while the blade carrier 340 is removed and replaced. This greatly reduces the amount of labor required and downtime of the machine to replace the blade 348 and/or the blade carrier 340.

In some embodiments, the body 342 of the blade carrier 340 can be made from a material (e.g., plastic) that wears more readily than the material (e.g., metal) of the conduit 332. In addition, in some embodiments, a majority of the surfaces of the nozzle assembly 300 that contact the film are on the body 342 of the blade carrier 340. In this way, a majority of the wear of the nozzle assembly 300 due to contact from the film during normal operation will be concentrated on the body 342 of the blade carrier 340. In other words, a majority of the wear of the nozzle assembly 300 due to contact from the film during normal operation will be on a “wear part” that is removable and replaceable in a toolless manner.

Depicted in FIGS. 11A, 11B, and 11C are exploded perspective, side, and top views, respectively, of an embodiment of a nozzle assembly 500 for use with closed channel web materials. The nozzle assembly 500 includes a manifold block 510, a nozzle 530, and a blade carrier 540. The nozzle assembly 500 is configured to convey gas from a gas source into a closed channel of an inflatable web material and to cut open the closed channel of the inflatable web material. In some embodiments, the gas source can be a gas line that can be coupled to a compressor, a pressure gas container (e.g., a cylinder), and the like. In some embodiments, the gas source may be connected directly to the manifold block 510 and/or coupled to the manifold block 510 via a connector.

The manifold block 510 includes a mounting portion 512. The mounting portion 512 of the manifold block 510 includes a gas inlet 514. In some embodiments, the gas inlet 514 is a threaded bore into which a threaded end of a connector can be coupled. In the depicted embodiment, the mounting portion 512 of the manifold block 510 includes mounting holes 516. In some embodiments, a fastener (e.g., a bolt, a machine screw, etc.) can be inserted through each of the mounting holes 516 to mount the manifold block 510 to a structure, such as a support structure of an automated packaging station. The manifold block 510 also includes a nozzle portion 518. The nozzle portion 518 of the manifold block 510 includes a gas outlet 520. The gas outlet 520 is in fluid communication with the gas inlet 514 so that gas that passes into the gas inlet 514 passes to the gas outlet 520. In the depicted embodiment, the nozzle portion 518 includes mounting holes 516 that allow the blade carrier 540 to be mounted to the manifold block 510.

The nozzle assembly 500 includes a nozzle 530. The nozzle 530 includes a conduit 532 that has a passageway 534 for passage of gas. The conduit 532 is configured to be coupled to the gas outlet 520 of the manifold block 510. In some embodiments, the conduit 532 is an aluminum tube that can be pressed into the gas outlet 520 to couple the nozzle 530 to the manifold block 510. In some embodiment, an end of the conduit 532 includes external threads that can be threaded into internal threads of the gas outlet 520 to couple the nozzle 530 to the manifold block 510.

In the depicted embodiment, the nozzle 530 includes a wear cap 536 that forms an outlet 538. In the depicted embodiment, the wear cap 536 is couplable to a distal end of end of the conduit 532 (e.g., an end of the conduit 532 opposite of the end of the conduit 532 that is coupled to the gas outlet 520). The wear cap 536 may contact a web material that is fed past the nozzle assembly 500, resulting in greater wear on the wear cap 536 than on other parts of the nozzle 530, such as the conduit 532. In some embodiments, the conduit 532 is made from a material (e.g., a metal, such as aluminum) that is more durable than a material (e.g., plastic) of the wear cap 536. In this way, the wear cap 536 may be a “wear part” that is intended to be replaced periodically but has a relatively low cost compared to the conduit 532. In the depicted embodiment, the wear cap 536 is configured to close off the end of the conduit 532.

The blade carrier 540 includes a body 542 that is couplable to the manifold block 510. In the depicted embodiment, the body 542 is couplable to the manifold block 510 via fasteners 541. In the depicted embodiment, the nozzle portion 518 of the manifold block 510 includes mounting holes 519 configured to receive the fasteners 541 such that the blade carrier 540 is configured to be coupled to the nozzle portion 518 of the manifold block 510. In some embodiments, the body 542 of the blade carrier 540 is made from a material that is the same or similar to the material of the conduit 532. In some embodiments, the body 542 of the blade carrier 540 is made from a material that is the different from the material of the conduit 532. For example, the body 542 of the blade carrier 540 can be made from a material (e.g., plastic) that wears more readily than the material (e.g., metal) of the conduit 532.

The blade carrier 540 also includes a guard 546. In the depicted embodiment, the guard 546 is coupled to one end of the body 542. The guard 546 extends forward so that a gap exists between the guard 546 and the conduit 532. In the depicted embodiment, the guard 546 extends forward beyond the front of the body 542. In some embodiments, the gap between the guard 546 and the conduit 532 is sufficiently small to prevent or deter a user from inserting a finger or other body part into the gap between the guard 546 and the conduit 532.

The blade carrier 540 is configured to hold a blade 548 in the gap between the portions of the body 542 and the guard 546. In the depicted embodiment, the conduit 532 includes a slot 550. In the depicted embodiment, the slot 550 is arranged so that, as the blade carrier is coupled to the manifold block 510, a bottom of the blade 548 slides into the slot 550. In the depicted embodiment, the blade 548 is arranged so that the blade 548 extends farther forward along the conduit 532 than the blade extends forward along the guard 546. In the depicted embodiment, the blade carrier 540 is removably couplable to the manifold block 510 so that, when the blade 548 will be replaced, the blade carrier 540 can be removed. At that point, the blade 548 can be removed from the blade carrier 540 and replaced with a new blade before the blade carrier 540 is again coupled to the manifold block. Alternatively, the entire blade carrier 540 (including the blade 548) can be discarded and a new blade carrier with a new blade can be coupled to the manifold block 110.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure.

Accordingly, it is expressly intended that all such variations, changes, and equivalents fall within the spirit and scope of the present disclosure, as claimed.

What is claimed is:

1. A system comprising:
a manifold block comprising a gas inlet and a gas outlet, wherein the gas outlet is in fluid communication with the gas inlet;
a nozzle configured to be coupled to the gas outlet of the manifold block, the nozzle including a conduit and a slot in the conduit; and
a blade carrier, comprising:
a body,
a guard coupled to the body, and
a blade coupled to the guard;
wherein the blade carrier is couplable to the manifold block so that so that a gap exists between the conduit and the guard; and
wherein the blade is coupled to the blade carrier such that, when the blade carrier is couple to the manifold block, the blade is located in the gap between the conduit and the guard and a portion of the blade is located in the slot.

2. The system of claim 1, wherein the guard of the blade carrier is configured to be aligned with the slot when the blade carrier is coupled to the manifold block.

3. The system of claim 1, wherein the nozzle further includes a wear cap configured to close an end of the conduit.

4. The system of claim 1, wherein the blade is arranged so that, when the blade carrier is coupled to the manifold block, the blade extends farther forward along the conduit than the blade extends forward along the guard.

5. The system of claim 1, wherein the blade carrier is removably couplable to the manifold block.

6. The system of claim 1, wherein the blade carrier is configured to be coupled to a nozzle portion of the manifold block.

7. A system comprising:
a manifold block comprising a gas inlet and a gas outlet, wherein the gas outlet is in fluid communication with the gas inlet;
a nozzle configured to be coupled to the gas outlet of the manifold block; and
a blade carrier, comprising:
a body having a bore therein,
a guard coupled to the body so that a gap exists between a portion of the body and a portion of the guard, and
a blade located in the gap between the portion of the body and the portion of the guard;
wherein the blade carrier is configured to be coupled to the manifold block in a toolless manner by sliding a portion of the nozzle through at least a portion of the bore until the blade carrier is in contact with the manifold block.

8. The system of claim 7, wherein the manifold block includes a slot and wherein the guard of the blade carrier is configured to be aligned with the slot when the blade carrier is coupled to the manifold block.

9. The system of claim 8, wherein the manifold block further includes side walls on either side of the slot, wherein the side walls are configured to deter rotation of the blade carrier.

10. The system of claim 8, wherein the manifold block further includes a ball detent in the slot.

11. The system of claim 10, wherein the guard includes a ball detent depression configured to engage the ball detent in the slot and wherein, when the ball detent is engaged with the ball detent depression, the ball detent depression deters the blade carrier from moving away from the manifold block.

12. The system of claim 7, wherein the nozzle includes a conduit configured to be coupled to the gas outlet of the manifold block.

13. The system of claim 12, wherein:
when the blade carrier is coupled to the manifold block, an end of the conduit extends beyond an end of the body of the blade carrier;
the end of the conduit that extends beyond the end of the body of the blade carrier includes a wear cap; and
the manifold block and the nozzle are configured such that gas can be inserted into the gas inlet of the manifold block, pass through the manifold block, pass out of the manifold block and into the conduit through the gas outlet, and then pass out of the conduit through the wear cap.

14. The system of claim 12, wherein:
when the blade carrier is coupled to the manifold block, the conduit remains inside of the bore;
the body of the blade carrier includes an outlet; and
the manifold block, the nozzle, and the blade carrier are configured such that gas can be inserted into the gas inlet of the manifold block, pass through the manifold block, pass out of the manifold block and into the conduit through the gas outlet, pass out of the conduit into the bore, and then pass out of the body of the blade carrier through the outlet.

15. The system of claim 14, wherein the body of the blade carrier includes a wear cap and wherein, when the blade carrier is coupled to the manifold block, the wear cap is on an end of the body that is furthest from the manifold block.

16. The system of claim 7, wherein:
the body includes a first slot;
the guard includes a second slot; and
a bottom of the blade is configured to slide in the first slot and a top of the blade is configured to slide in the second slot.

17. The system of claim 16, wherein the blade carrier includes a set screw configured to hold the blade in place with respect to the body and the guard.

18. The system of claim 16, wherein the blade is arranged so that the blade extends farther forward along the body than the blade extends forward along the guard.

19. The system of claim 7, wherein the gas inlet is configured to be coupled to a connector and wherein the connector is configured to be coupled to a gas source.

20. The system of claim 7, wherein the manifold block includes a mounting portion and a nozzle portion, wherein the gas inlet is in the mounting portion, and wherein the gas outlet is in the nozzle portion.

21. The system of claim 20, wherein the nozzle portion is narrower than the mounting portion.

22. The system of claim 20, wherein a width of the nozzle portion is similar to a width of the body.

23. A method comprising:
mounting a manifold block to a support structure;
coupling a gas inlet of the manifold block to a gas source;
coupling a nozzle to a gas outlet of the manifold block, wherein the gas inlet is in fluid communication with the gas outlet; and
coupling, in a toolless manner, a blade carrier to the manifold block by sliding a portion of the nozzle through at least a portion of a bore of the blade carrier until the blade carrier is in contact with the manifold block;
wherein the bore of the blade carrier is in a body of the blade carrier; and
wherein the blade carrier further includes:
a guard coupled to the body so that a gap exists between a portion of the body and a portion of the guard, and
a blade located in the gap between the portion of the body and the portion of the guard.

24. The method of claim 23, wherein the manifold block includes a slot and wherein coupling the blade carrier to the manifold block further includes aligning the guard with the slot.

25. The method of claim 23, wherein the blade carrier is in contact with the manifold block when a ball detent of the manifold block is engaged with a ball detent depression in the blade carrier.

26. The method of claim 23, wherein a web material includes a closed channel in fluid communication with a plurality of chambers, and wherein the method further comprises:
feeding the web material past the manifold block so that the closed channel passes around the body of the blade carrier and the closed channel is cut by the blade.
